(19) United States
(12) Patent Application Publication
(10) Pub. No.: US 2013/0033164 A1
(43) Pub. Date: Feb. 7, 2013

(54) PLANAR REMOTE PHOSPHOR ILLUMINATION APPARATUS

(71) Applicant: Yosi Shani, Maccabim (IL)

(72) Inventor: Yosi Shani, Maccabim (IL)

(21) Appl. No.: 13/566,356

(22) Filed: Aug. 3, 2012

Related U.S. Application Data
(60) Provisional application No. 61/514,502, filed on Aug. 3, 2011.
(60) Provisional application No. 61/558,443, filed on Nov. 11, 2011.

(51) Int. Cl. H05B 33/12

(52) U.S. Cl. 313/46; 313/498

(57) ABSTRACT

In various embodiments, reduced phosphor utilization and improved off-state appearance are facilitated in an illumination apparatus via incorporation of segmented phosphor and/or reflector layers.

### CROSS-REFERENCE TO RELATED APPLICATIONS

This application claims priority to and the benefit of U.S. Provisional Patent Application No. 61/514,502, filed on Aug. 3, 2011, and U.S. Provisional Patent Application No. 61/558,443, filed on Nov. 11, 2011, the entire disclosure of each of which is incorporated by reference herein.

### FIELD OF THE INVENTION

In various embodiments, the present invention relates to artificial illumination, and in particular to an illumination apparatus incorporating a remote phosphor.

### BACKGROUND

Light-emitting diodes (LEDs) are gradually replacing incandescent light bulbs in various applications, including traffic signal lamps, large-sized full-color outdoor displays, various lamps for automobiles, solid-state lighting devices, flat panel displays, and the like. Conventional LEDs typically include a light-emitting semiconductor material, also known as the bare die, and numerous additional components designed for improving the performance of the LED. These components may include a light-reflecting cup mounted below the bare die, a transparent encapsulation (typically silicone) surrounding and protecting the bare die and the light reflecting cup, and electrical leads for supplying the electrical current to the bare die. The bare die and the additional components are efficiently packed in an LED package.

The advent of blue- and ultraviolet-emitting LEDs has enabled the widespread deployment of LED-based white light sources for, e.g., general lighting applications and backlights for liquid crystal displays. In many such light sources, a portion the high-frequency light of the LED is converted to light of a different frequency, and the converted light combines with unconverted light to form white light. Yellow-emitting phosphors have been advantageously combined with blue LEDs in this manner. One popular configuration for LEDs and phosphors is the “remote-phosphor” arrangement, in which the phosphor and the LED are spatially separated to maintain the phosphor at a lower temperature during LED operation and thereby improves efficiency of the phosphor. The distance between the LED and the phosphor also helps to reduce the amount of light that is backscattered from the phosphor and absorbed by the LED itself (which lowers the overall efficiency of the device).

FIG. 1 schematically depicts a conventional remote-phosphor LED lighting device 100, in which the LED 110 is spatially separated from a phosphor layer 120 on a waveguide 130. While the distance between the LED 110 and the phosphor layer 120 improves illumination efficiency, as described above, this configuration does have disadvantages. First, as shown in FIG. 1, the phosphor layer is often applied to the exit surface of the waveguide (as that is typically the farthest point from the LED), but the exit surface is often quite large. Thus, a large amount of phosphor material, which is typically exotic and/or expensive, is required. For example, the planar lighting device 100 has a large exit surface that requires a significant amount of phosphor in the coating phosphor layer 120. This results in low utilization of the phosphor (in terms of light intensity emitted per amount of phosphor in the coating), which may be expensive. Second, since the particular LED/phosphor combination in the lighting device constrains the choice of suitable phosphor materials, the lighting device may require use of a phosphor material that has an undesirable color when the lighting device is in the off state (i.e., not emitting light). For example, many conventional phosphors have yellow and/or green hues that dictate the color of (at least a large portion of) the lighting device itself in the off state. In many applications it may be desirable for the lighting device to have a different (or even controllable) appearance in the off state. Third, in some luminaires that incorporate an additional cover over a phosphor layer, a portion of the emitted light is reflected back from the cover (or window) back into the wavelength-converting phosphor layer. In such cases, the back-reflected light is wavelength-converted yet again by the phosphor, resulting in an undesirable shift in the overall output spectrum of the luminaire. Thus, there is a need for remote-phosphor lighting devices that utilize less phosphor material without significantly impacting performance and the off-state color of which may be controlled and/or unconstrained by the color of the phosphor material itself, and also with minimal undesirable spectral shifts in output light from luminaires in which they may be placed.

### SUMMARY

In accordance with various embodiments of the present invention, LED-based illumination devices incorporate remotely situated phosphors in configurations utilizing less phosphor material that traditional devices and that enable control over the off-state appearance of the device. In general, preferred embodiments of the invention feature phosphor and reflector configurations that force at least some light within a waveguide to travel through the phosphor multiple times prior to being emitted from the illumination device, thereby increasing the probability that some of the light will be converted from one wavelength to another. For example, embodiments of the invention incorporate a segmented layer of phosphor (or “photoluminescent material”—these terms are utilized interchangeably herein) that does not coat the entire exit surface of the waveguide. Rather, the segmented layer of phosphor coats a sufficient area of the exit surface such that converted light emerging from the phosphor combines with unconverted light exiting from the waveguide between phosphor-coated surface regions to form combined light of a desired wavelength or color (e.g., white). As utilized herein, a “segmented” layer covers only a portion of a surface, and is typically composed of discrete regions in any desired shape. However, segmented layers may also be composed of one or more straight or sinuous regions that are continuous yet cover only a portion of a surface with gaps between the regions (or portions of a single region). Alternatively, one or more of the gaps in the segmented phosphor layer may be coated with opaque layers (e.g., reflectors) such that the illumination device emits light only from the small regions coated with the phosphor. Such configurations reduce the amount of phosphor required while not significantly impacting the overall emission efficiency of the device, which is also at least partially enabled by utilization, within preferred embodiments of the invention, of high-reflectivity bottom mirrors and low-loss waveguides.

In other embodiments of the present invention, thin phosphor layers may be covered with a segmented opaque reflector layer (e.g., one formed of discrete reflecting elements) such that at least some of the light emitted from the device is reflected through the phosphor multiple times beforehand. These multiple traversals of the phosphor layer increase the amount of light that is converted, obviating the need for a thick phosphor layer for adequate conversion efficiency and reducing the amount of required phosphor material. Furthermore, the segmented opaque layer may be coated with one or more alternative colors that give the illumination device a color or appearance in the off state different from the color of the phosphor material itself. For example, the opaque segments may be coated with the color complementary to that of the phosphor material in the off state, thereby giving the illumination device a white color when viewed at a distance. In some embodiments of the invention multiple segmented opaque reflector layers are utilized to adjust the overall luminance of the emitted light. For example, one reflector layer may be moved relative to the other, either opening or closing emission paths for the emitted light.

In an aspect, embodiments of the invention feature an illumination apparatus including a substantially planar waveguide having (i) top and bottom opposed surfaces, (ii) an in-coupling region for receiving light, and (iii) an out-coupling region for emitting light. The out-coupling region includes at least a portion of the top surface of the waveguide. The illumination apparatus also includes at least one light source for emitting light into the in-coupling region, an out-coupling structure for disrupting total internal reflection of light within the waveguide such that the light is emitted from the out-coupling region, and a segmented layer of photoluminescent material (different from the out-coupling structure) for converting a portion of light emitted from the out-coupling region to a different wavelength. The out-coupling structure is disposed at least in the out-coupling region. The segmented layer of photoluminescent material is disposed over the out-coupling region to form a gap between each segment of the segmented layer of photoluminescent material and the top surface of the waveguide. The gap is preferably an air gap, but in some embodiments the gap may be filled with a material having an index of refraction different from the waveguide and/or the photoluminescent material.

Embodiments of the invention may feature one or more of the following in any of a variety of combinations. The illumination apparatus may include a reflector for preventing emission of light from the bottom surface. The reflector may be disposed proximate the bottom surface of the waveguide at least in the out-coupling region. The at least one light source may emit light of a first color, and light of the first color may be emitted from the out-coupling region between segments of the segmented layer of photoluminescent material. The segments of the segmented layer of photoluminescent material may emit light of a second color different from the first color, and light of the first and second colors may combine to form light of a third color (e.g., white). The out-coupling structure may include or consist essentially of a plurality of discrete optical elements (e.g., prisms, hemispheres, and/or diffusive dots (which may have arbitrary shapes and are not necessarily circular)). The spacing between segments of the segmented layer of photoluminescent material may be substantially constant as a function of distance away from the at least one light source. The spacing between optical elements may decrease as a function of distance away from the at least one light source.

The illumination apparatus may include a plurality of opaque (i.e., substantially preventing light transmission therethrough) reflectors each disposed between segments of the segmented layer of photoluminescent material. The top surfaces of the opaque reflectors and the segments of the segmented layer of photoluminescent material may be substantially coplanar. Each of the opaque reflectors may include or consist essentially of a metal (and/or a non-metallic thermally conductive material), and each may be thermally connected to a heat sink proximate an edge of the waveguide. The segments of the segmented layer of photoluminescent material may be a first color in the absence of light emission therefrom, and the top surfaces of a first portion of the opaque reflectors may be a second color different from the first color. The second color may be complimentary to the first color, and at least a portion of the top surface of the illumination apparatus encompassing the segmented layer of photoluminescent material and the first portion of the opaque reflectors may appear white to the human eye. Top surfaces of a second portion of the opaque reflectors may be a third color (and/or one or more additional colors) different from the first and second colors. The second portion of opaque reflectors may be arranged in a predetermined pattern (e.g., a name, logo, message, picture, etc.).

The out-coupling structure may include or consist essentially of a segmented layer of optical elements, the segments of which may be arranged to direct light (not necessarily all of the light within the waveguide or entering the out-coupling region) toward segments of the segmented layer of photoluminescent material. The out-coupling structure may include or consist essentially of a segmented layer of optical elements arranged to direct light toward specific areas of the top surface of the waveguide, and the segments of the segmented layer of photoluminescent material may be movable relative to the specific areas of the top surface of the waveguide. The correlated color temperature of light emitted by the illumination apparatus may be dependent on locations of the segments of the segmented layer of photoluminescent material. An optical diffuser may be disposed over the segmented layer of photoluminescent material. The out-coupling structure may be disposed proximate the bottom surface (or even the top surface) of the waveguide.

In another aspect, embodiments of the invention feature an illumination apparatus including a substantially planar waveguide having (i) top and bottom opposed surfaces, (ii) an in-coupling region for receiving light, and (iii) an out-coupling region for emitting light. The out-coupling region includes at least a portion of the top surface of the waveguide. The illumination apparatus also includes at least one light source for emitting light into the in-coupling region, an out-coupling structure for disrupting total internal reflection of light within the waveguide such that the light is emitted from the out-coupling region, a (preferably continuous) layer of photoluminescent material for converting a portion of light emitted from the out-coupling region to a different wavelength, and a plurality of opaque reflectors having spaces therebetween. The out-coupling structure is disposed at least in the out-coupling region and is different from the layer of photoluminescent material and the plurality of opaque reflectors. The layer of photoluminescent material is disposed over the out-coupling region to form a gap between the layer of photoluminescent material and the top surface of the waveguide. The gap is preferably an air gap, but in some embodiments the gap may be filled with a material having an index of refraction different from the waveguide and/or the photoluminescent material. The opaque reflectors are disposed over the layer of photoluminescent material, and light is emitted from the illumination apparatus only through the spaces.

Embodiments of the invention may feature one or more of the following in any of a variety of combinations. The layer of photoluminescent material may be a first color in the absence of light emission therefrom, and the top surfaces of a first portion of the opaque reflectors may be a second color different from the first color. The second color may be complimentary to the first color, and at least a portion of the top surface of the illumination apparatus encompassing a portion of the layer of photoluminescent material and the first portion of the opaque reflectors may appear white to the human eye. Top surfaces of a second portion of the opaque reflectors may be a third color (and/or one or more additional colors) different from the first and second colors. The second portion of opaque reflectors may be arranged in a predetermined pattern (e.g., a name, logo, message, picture, etc.). The spacing between opaque reflectors as a function of distance from the at least one light source may increase, decrease, be approximately constant, or vary in a predetermined manner. The illumination apparatus may include a second plurality of opaque reflectors disposed over the plurality of opaque reflectors. Relative motion between the plurality of opaque reflectors and the second plurality of opaque reflectors may alter the luminance of light emitted from the illumination apparatus. The out-coupling structure may include or consist essentially of a plurality of discrete optical elements (e.g., prisms, hemispheres, and/or diffusive dots). The out-coupling structure may be disposed proximate the bottom surface of the waveguide. Each of the opaque reflectors may include or consist essentially of a thermally conductive material and may be thermally connected to a heat sink proximate an edge of the waveguide.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, the terms “substantially” and “approximately” mean ±10%, and in some embodiments, ±5%, unless otherwise indicated. The term “consists essentially of” means excluding other materials or structures that contribute to function, unless otherwise defined herein. The term “photoluminescent material” is commonly used herein to describe one or a plurality of photoluminescent materials (which exhibit, for example, chemoluminescence, fluorescence, and/or phosphorescence), e.g., in layered or mixed form. Additionally, a photoluminescent material may comprise one or more types of photoluminescent molecules. In any event, a photoluminescent material is characterized by an absorption spectrum (i.e., a range of wavelengths of light which may be absorbed by the photoluminescent molecules to effect quantum transition to a higher energy level) and an emission spectrum (i.e., a range of wavelengths of light which are emitted by the photoluminescent molecules as a result of quantum transition to a lower energy level). The emission spectrum of the photoluminescent layer is typically wider and shifted relative to its absorption spectrum.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a cross-sectional schematic of a conventional remote-phosphor LED-based illumination device;

FIG. 2 is a cross-sectional schematic of in-coupling and out-coupling regions of an illumination device in accordance with various embodiments of the invention;

FIGS. 3A and 3B are cross-sectional schematics of out-coupling regions of illumination devices incorporating segmented phosphor layers in accordance with various embodiments of the invention;

FIGS. 4A and 4B are, respectively, a cross-sectional schematic and a plan view of an out-coupling region of an illumination device incorporating segmented phosphor and reflector layers in accordance with various embodiments of the invention;

FIGS. 5A, 5B, and 5C are cross-sectional schematics of out-coupling regions of illumination devices incorporating segmented reflector layers in accordance with various embodiments of the invention;

FIGS. 5D and 5E are cross-sectional schematics depicting two different positions of a movable segmented phosphor layer of an out-coupling region of an illumination device in accordance with various embodiments of the invention;

FIG. 6 is a chromaticity diagram depicting output colors of illumination devices in accordance with various embodiments of the invention;

FIG. 7 is a plan view of an illumination device incorporating colored reflective segments arranged in a predetermined pattern in accordance with various embodiments of the invention; and

FIGS. 8A-8C are cross-sectional schematics of alternative illumination devices in accordance with various embodiments of the invention.

### DETAILED DESCRIPTION

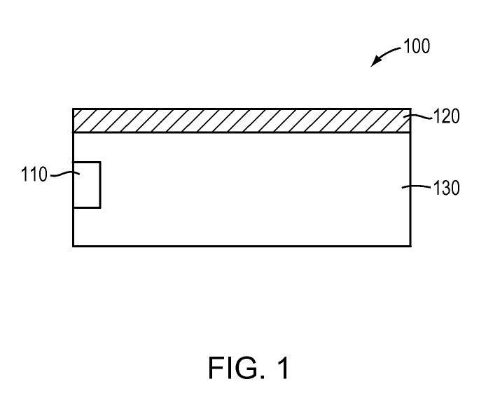

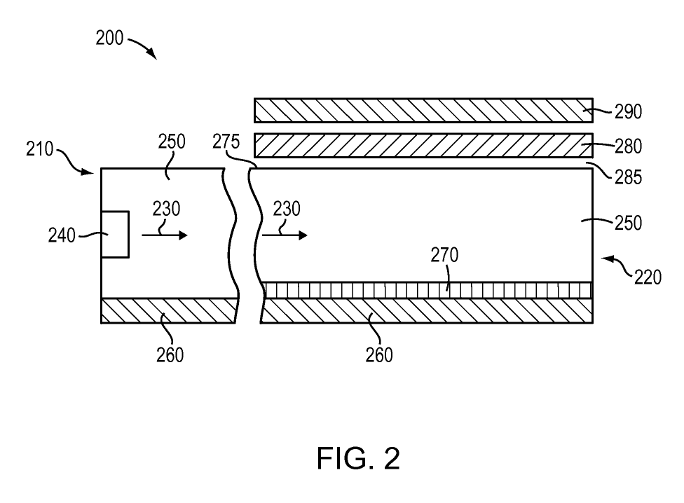

FIG. 2 depicts an illumination device 200 in accordance with embodiments of the present invention. As shown, illumination device 200 includes an in-coupling region 210 and an out-coupling region 220. (As out-coupling region 220 is typically much larger than in-coupling region 210, FIG. 2 depicts these features with a schematic break therebetween, although regions 210, 220 are typically portions of a single unified whole. Furthermore, subsequent figures typically omit in-coupling region 210 for clarity, but all illustrated embodiments will typically include an in-coupling region.) Within the in-coupling region 210, light 230 from one or more LEDs 240 (e.g., LED bare dies, packaged LEDs, or other discrete light sources) is coupled within waveguide 250, where it is typically confined by total internal reflection. As shown in FIG. 1, the LED 240 may be embedded within waveguide 250, with an optional encapsulating layer (e.g., an index-matching material, not shown) therebetween, or the LED 240 may be physically located outside of waveguide 250. Additionally, while FIG. 1 illustrates LED 240 as emitting light into a side surface of waveguide 250, LED 240 may be coupled to or embedded within waveguide 250 at another surface (e.g., the bottom surface). Typically a reflector 260 is disposed along one or more surfaces of waveguide 250 where light emission is not desired; however, in some embodiments light is emitted through a phosphor layer 280 (or other phosphor- and/or reflector-containing arrangements detailed herein) disposed on multiple surfaces of waveguide 250. The waveguide 250 is preferably substantially optically transparent, but may also incorporate various features (e.g., scatterers, reflectors, etc.) for the in-coupling, reflection, and out-coupling of light confined therein. The waveguide 250 may include or consist essentially of one or more polymeric materials, e.g., latex, polyvinylchloride, nitrile, chloroprene (Neoprene), poly(cis-isoprene), poly(2,3-dimethylbutadiene), poly(dimethylsiloxane), ethylene/vinyl acetate copolymer-40% vinyl acetate, ethylene/vinyl acetate copolymer-30% vinyl acetate, poly(butadiene-co-acrylonitrile), natural rubber, poly(chloroprene), polymethylmethacrylate, and/or polycarbonate. In alternative embodiments, the waveguide 250 is replaced by a “lightbox” arrangement in which reflectors 260 surround a substantially empty space in which light is confined until its exit through an exit aperture covered by the phosphor layer 280 (or other phosphor- and/or reflector-containing arrangements described below).

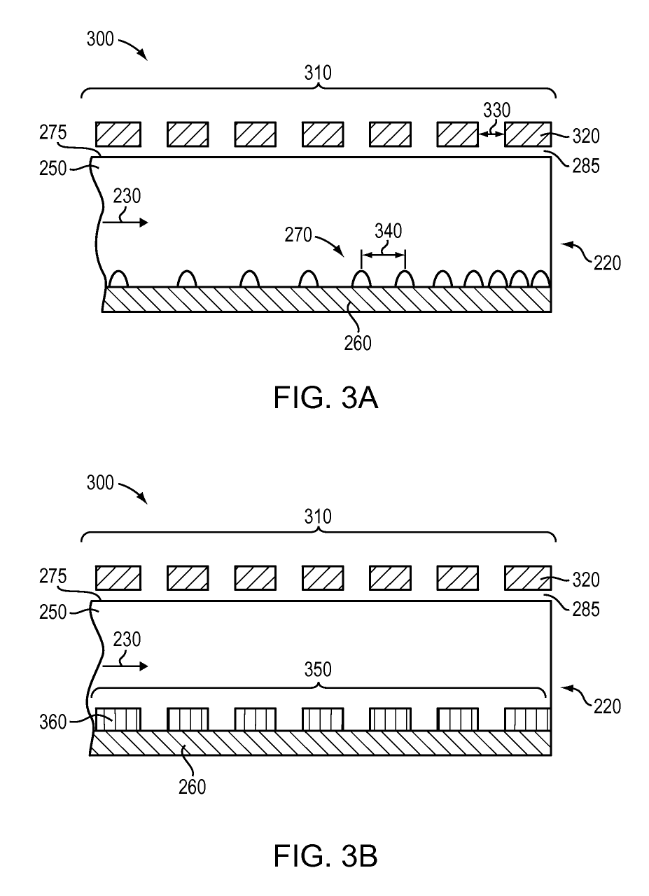

In out-coupling region 220, the light 230 is out-coupled from waveguide 250 and emitted into the surrounding ambient. Within out-coupling region 220, an out-coupling structure 270 disrupts the total internal reflection of light 230, causing it to be out-coupled through an exit surface 275 of waveguide 250. The out-coupling structure 270 may include or consist essentially of a plurality of discrete optical elements (as shown in more detail in FIG. 3), e.g., prisms, hemispheres, and/or diffusive dots, and may be disposed within waveguide 250 or on a surface thereof. Such optical elements may be uniformly distributed or their spacing (e.g., linear or areal) may change along a dimension of waveguide 250 (e.g., as a function of distance away from in-coupling region 210 and LED 240) to control the uniformity of light emitted from out-coupling region 220. Upon exiting surface 275, the light strikes a phosphor layer 280, where at least a portion of the light is converted to a different wavelength. Typically only a fraction of the light is converted, while other light passes through without being converted. In order to minimize the amount of phosphor material utilized, phosphor layer 280 is typically only approximately 10-20 μm thick, compared to conventional phosphor thicknesses of 30 μm or more.

As shown in FIG. 2, in order not deleteriously impact the total-internal-reflection condition within waveguide 250, the phosphor layer 280 is separated from surface 275 by an air gap 285. The air gap 285 may have a thickness in the range of, e.g., approximately 1 μm to approximately 1000 μm. Disposed above phosphor layer 280 is a semitransparent mirror 290 that reflects back, or “recycles” a portion of the light emanating from phosphor layer 280 back toward waveguide 250 while transmitting the remaining light (i.e., a mixture of unconverted light and light converted by phosphor layer 280) into the surrounding ambient. In this manner, portions of the light emitted from surface 275 are cycled through the phosphor layer multiple times, thereby increasing the probability of a wavelength-conversion event even for a phosphor layer 280 having a reduced thickness. The light back-reflected by semitransparent mirror 290 may reenter waveguide 250 but will be reflected back toward phosphor layer 280 by reflector 260 and/or out-coupling structure 270. As shown in FIG. 2, a micrometer-scale air gap may be disposed between the phosphor layer 280 and semitransparent mirror 290, or semitransparent mirror 290 may be disposed directly on phosphor layer 280.

FIGS. 3A and 3B depict embodiments of the present invention in which the amount of phosphor material in an illumination device 300 is reduced via the use of a segmented phosphor layer. As shown, disposed over (and preferably separated by air gap 285) exit surface 275 of illumination device is a segmented phosphor layer 310, which may include or consist essentially of multiple phosphor segments 320. (As mentioned above, while in many embodiments the segmented phosphor layer is composed of multiple discrete segments, in many embodiments it is composed of one or more sinuous segments defining one or more phosphor-free zones.) In some embodiments, at least a portion of light traversing the phosphor segments 320 is wavelength-converted, and mixes with unconverted light emitted through surface 275 between the phosphor segments 320. As shown in FIG. 3A, a spacing 330 (e.g., linear or areal) of segments 320 may be substantially constant across the surface 275, while a spacing 340 between optical elements of out-coupling structure 270 may change (e.g., decrease) along waveguide 250 (e.g., as a function of distance away from LED 240). In an alternative embodiment, the spacing 340 remains approximately constant along waveguide 250 but the height (or other parameter enhancing the out-coupling “strength”) of the optical elements may change (e.g., increase) along waveguide 250 (e.g., as a function of distance away from LED 240).

However, in a preferred embodiment of the invention, depicted in FIG. 3B, light 230 within the waveguide 250 is directed preferentially toward the phosphor segments 320 via a segmented out-coupling structure 350 composed of out-coupling segments 360 positioned to direct out-coupled light toward (and, optionally, substantially spatially aligned with) the segments 320. In this manner, most or substantially all of the out-coupled light travels through segments 320 (where it may be wavelength-converted) prior to emission into the surrounding ambient. Although such output light may be less uniform (as it may thus itself be “segmented”), a diffuser may be disposed over the segments 320 to homogenize the light, or such embodiments may be utilized in applications where the gap between segments 320 is very small (e.g., less than 1 cm, or even less than 1 mm) and therefore substantially not noticeable. As further detailed below, the portions of surface 275 between segments 320 may be colored to provide the illumination device 300 with an overall color, in the off state, different from that of the phosphor in segments 320. For example, such portions may be colored with the complementary color of that of the segments 320, and thus the top of the device 300 may appear to be white, at least at some distance away.

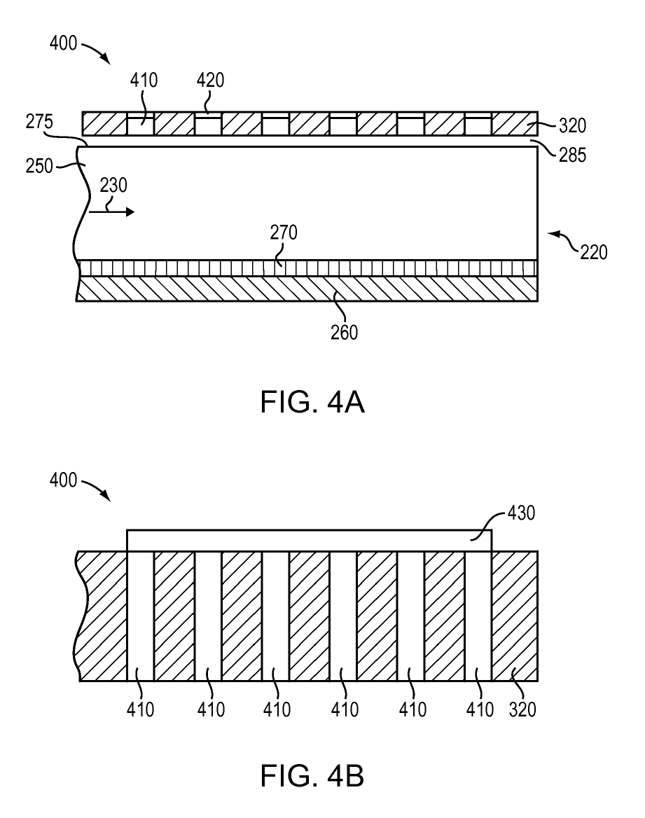

The production of such segmented output light may also be accomplished via the combined utilization of segmented phosphor layers and segmented reflectors, as shown in FIGS. 4A and 4B. FIG. 4A depicts an illumination device 400 similar to illumination device 300 but that features a segmented reflector composed of opaque reflector segments 410 positioned between the phosphor segments 320. The reflector segments 410 prevent light emission therethrough so that the only light emitted by illumination device 400 passes through the phosphor segments 320. As described above, an optional diffuser may be disposed above the segments 320, 410 if greater homogeneity of the emitted light is desired, and/or the segments 320, 410 may have a small edge length or diameter, e.g., of less than 1 cm, or even less than 1 mm. The surfaces of the reflector segments 410 may be substantially coplanar with those of the phosphor segments 320. As also described above, a colorant 420 may be applied to the top surfaces of segments 410 to provide the top surface of illumination device 400 with an overall color or appearance in the off state different from that of the phosphor material in segments 320.

In embodiments in which illumination device 400 (or other illumination devices described herein) is utilized in a luminaire with a separate cover or window over the illumination device, the undesirable shift in the overall output spectrum of the luminaire described above may be reduced or substantially eliminated because at least a portion of light back-reflected by the cover will be reflected back out (without further wavelength shift due to phosphor interaction) by reflector segments.

Optical simulations were performed of the structure of FIG. 4A, assuming a 1:1 ratio of phosphor segments 320 and reflector segments 410. The reflectivity of the reflector segments 410 was assumed to be diffusive with a reflectivity of 98%, and optical losses from the waveguide 250 itself were assumed to be negligible. Compared to a control device not utilizing segmented phosphor and reflector layers, optical losses in this structure totaled only approximately 4%—a fairly low loss considering that the illumination device 400 of FIG. 4A utilizes significantly less phosphor material.

As shown in FIG. 4B, the segments 410 of the segmented reflector may also facilitate transfer of heat away from the phosphor segments 320. Even though illumination devices described herein have remote-phosphor arrangements, which help reduce the amount of heat build-up in the phosphor, the phosphor may still heat up during operation (since light is wavelength-converted at the phosphors to lower frequencies, i.e., lower photon energies, and since some light is absorbed in the phosphor layer), particularly because air gaps such as air gap 285 typically have low thermal conductivity. Segments 410 may include or consist essentially of a metal or other thermally conductive material and may thus draw heat away from segments 320 during operation. As shown in FIG. 4B, the segments 410 (shown here as linear segments; the segments may have any desired shape) may be thermally and/or physically coupled to a heat sink 430 that may be disposed proximate a surface of the illumination device 400. The heat sink 430 may include or consist essentially of metal or another thermally conductive material, and may even incorporate fins or other projections to facilitate conduction of heat away from illumination device 400.

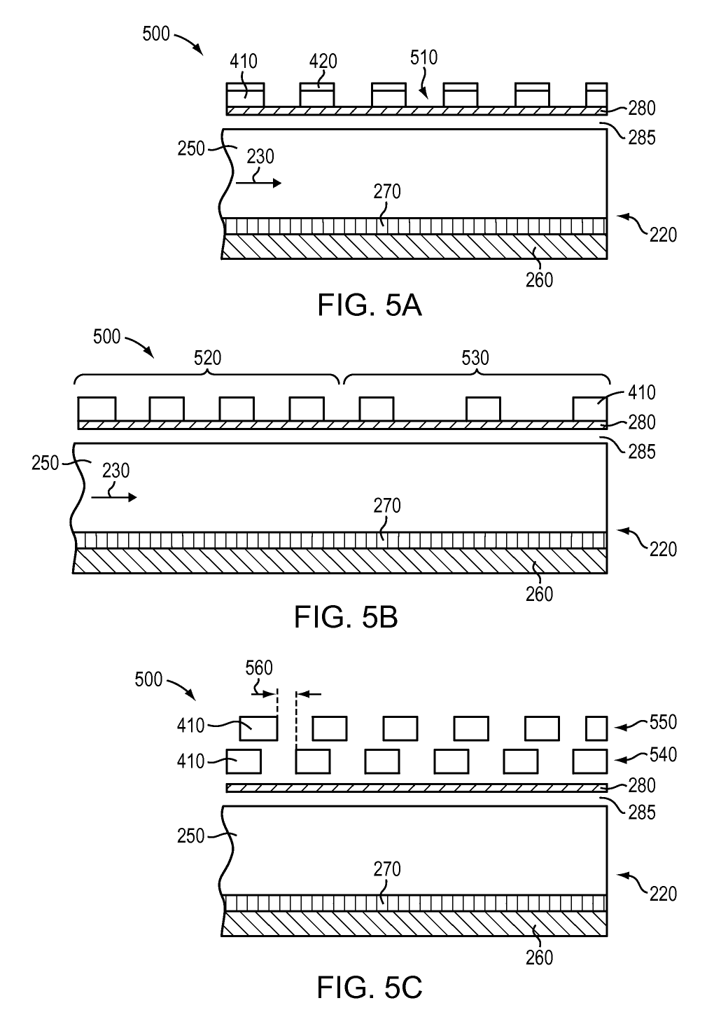

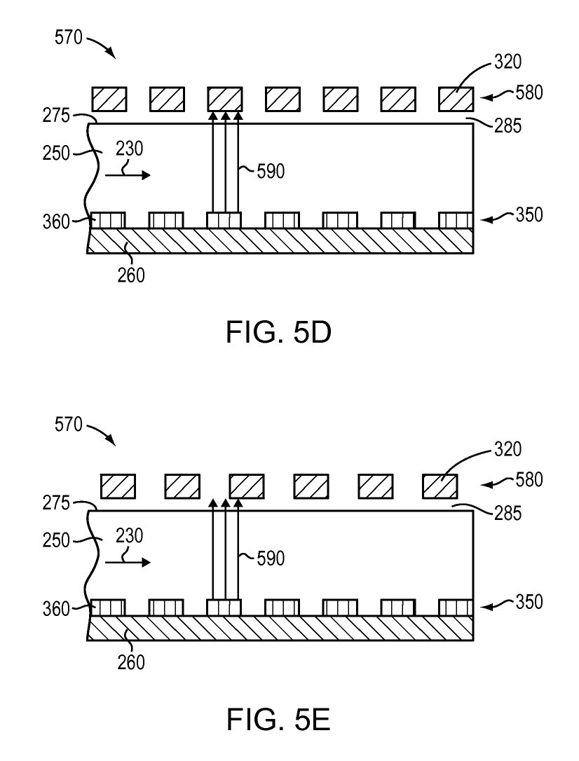

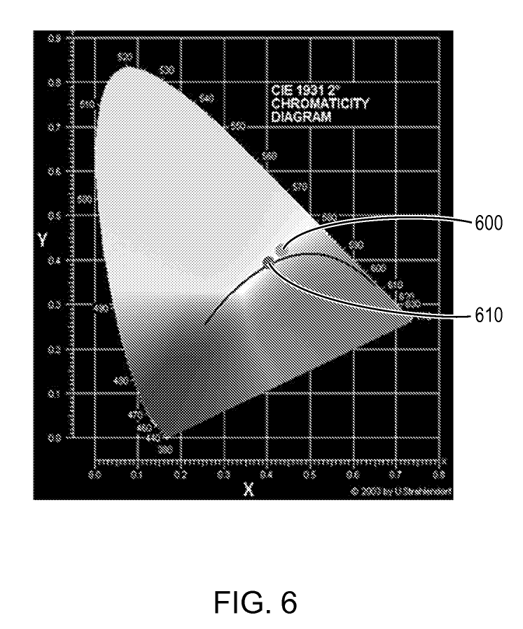

Various embodiments of the present invention produce segmented light from a thin continuous phosphor layer 280 combined with one or more segmented reflectors, as shown in FIGS. 5A, 5B, and 5C. As shown in FIG. 5A, a segmented reflector composed of reflector segments 410 may be disposed over (and optionally separated by an air gap from) phosphor layer 280 such that light is only emitted from illumination device 500 from areas 510 not covered by reflector segments 410. One advantage of this configuration (as well as that of FIG. 4A) is the ability to tune the correlated color temperature (CCT) of the light emitted by illumination device 500 by controlling the density of reflector segments 410 (and thus the amount of light that is recycled through the phosphor layer 280 multiple times). For example, the illumination device 500 shown in FIG. 5B contains a region 520 with a high (linear or areal) density of segments 410 and a region 530 with a lower density of segments 410. Since region 530 has a lower density of reflector segments 410, light emitted therefrom will typically exhibit an increased CCT compared to light emitted from region 520. This effect is illustrated in FIG. 6, which depicts the output color 600 of an illumination device incorporating a segmented reflector layer (such as illumination device 500) compared to the output color 610 of a similar device without the segmented reflector layer. As shown, the output color is altered as a function of the light recycling enabled by the segmented reflector layer. Although if regions 520, 530 are otherwise equivalent, the luminance of light emitted from region 520 will be lower, the arrangement and/or spacing of optical elements in out-coupling structure 270 may be locally adjusted to preferentially increase the luminance in region 520 and compensate for the larger area blocked by segments 410. Thus, in various embodiments of the present invention, the spacing (linear or areal) between reflector segments 410 may increase, decrease, remain approximately constant, or vary in a predetermined manner (based on locally desired CCT, for example) as a function of distance away from LED 240 or in the direction perpendicular thereto, as desired by the designer.

As shown in FIG. 5C, embodiments of the invention incorporate the ability to tune the CCT and/or luminance of output light via the use of multiple overlapping segmented reflector layers 540, 550 each composed of reflector segments 410. In such embodiments, one or both of segmented reflector layers 540, 550 are movable, and relative motion therebetween adjusts the size of gaps 560 through which output light emanates. In this manner, the CCT of illumination device 500 may be altered as desired.

The CCT of illumination devices in accordance with embodiments of the present invention may also be varied by making a segmented phosphor layer movable relative to the exit surface of a waveguide. Referring to FIG. 5D, an illumination device 570 features a movable segmented phosphor layer 580 that includes one or more phosphor segments 320. As shown, movable layer 580 may be separated from exit surface 275 by air gap 285. As described above with reference to FIG. 3B, light 230 within the waveguide 250 is directed preferentially toward the phosphor segments 320 via segmented out-coupling structure 350 composed of out-coupling segments 360 positioned to direct out-coupled light toward (and, optionally, substantially spatially aligned with) the segments 320. In this manner, most or substantially all of the out-coupled light travels through segments 320 (where it may be wavelength-converted) prior to emission into the surrounding ambient. FIG. 5D depicts light 590 being out-coupled by a segment 360 (and only one segment 360 for clarity; typically each segment 360 would direct light to one or more segments 320) toward a segment 320 where at least a portion of the light 590 is wavelength converted and emitted. Each segment 360 may direct light to one or more segments 320; however, by using a directional out-coupling configuration (e.g., prismatic optical elements and a thin waveguide or a configuration in which the segments 360 are at the top surface of the waveguide) most of the redirected light from each segment 360 may be directed towards a specific segment 320. In alternative embodiments, each segment 320 may be sufficiently large (compared to segments 360) to receive light rays from multiple segments 360. Such light collectively out-coupled by all of the segments 360 is emitted by illumination device 570 and has a particular CCT.

As shown in FIG. 5E, in various embodiments of the invention, illumination device 570 emits light of a different CCT (relative to the arrangement in FIG. 5D) due to movable segmented phosphor layer 580 being moved relative to exit surface 275 and/or segmented out-coupling structure 350. As shown, at least a portion of the light 590 out-coupled by the segments 360 is directed into the spaces between segments 320 rather than directly at segments 320. Thus, relatively less of the light 590 will pass through segments 320 and be wavelength converted, resulting in a different CCT of the light emitted by illumination device 570.

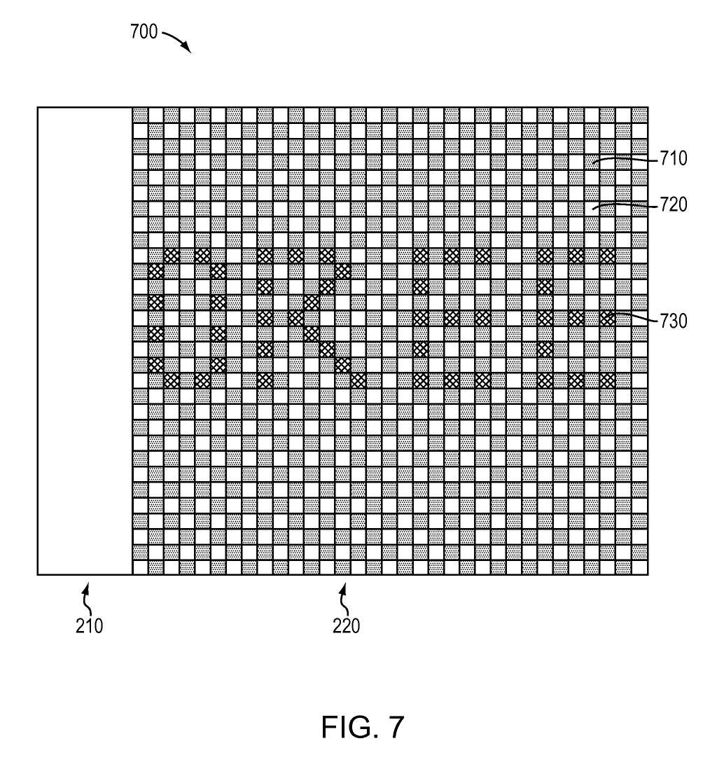

As described above, various segments (e.g., reflector segments 410) of illumination devices that are located between phosphor segments may be colored to give the illumination device a desired color and/or appearance in the off state. As shown in FIG. 7, this concept may be extended for more complicated decorative purposes via the use of multiple alternative colors for such segments (or, equivalently, the intentional addition of color to only a subset of such segments). FIG. 7 depicts the top view of an illumination device 700 in which the out-coupling region 220 is composed of phosphor segments 710, reflective segments 720, and colored segments 730, where the colored segments 730 are arranged in a predetermined pattern, e.g., a company name, logo, or other selected image or picture. As shown, the colored segments 730 are reflective segments having an alternative color applied to them, i.e., light is emitted from illumination device 700 only from the phosphor segments 710. In embodiments of the invention, the pattern defined by the colored segments 730 is only visible to observers when the illumination device 700 is in the off state; in the on state mainly only the light emitted from phosphor segments 710 is visible. In other embodiments of the invention, the pattern defined by the colored segments 730 is visible to observers when the illumination device 700 is in the off state or the on state.

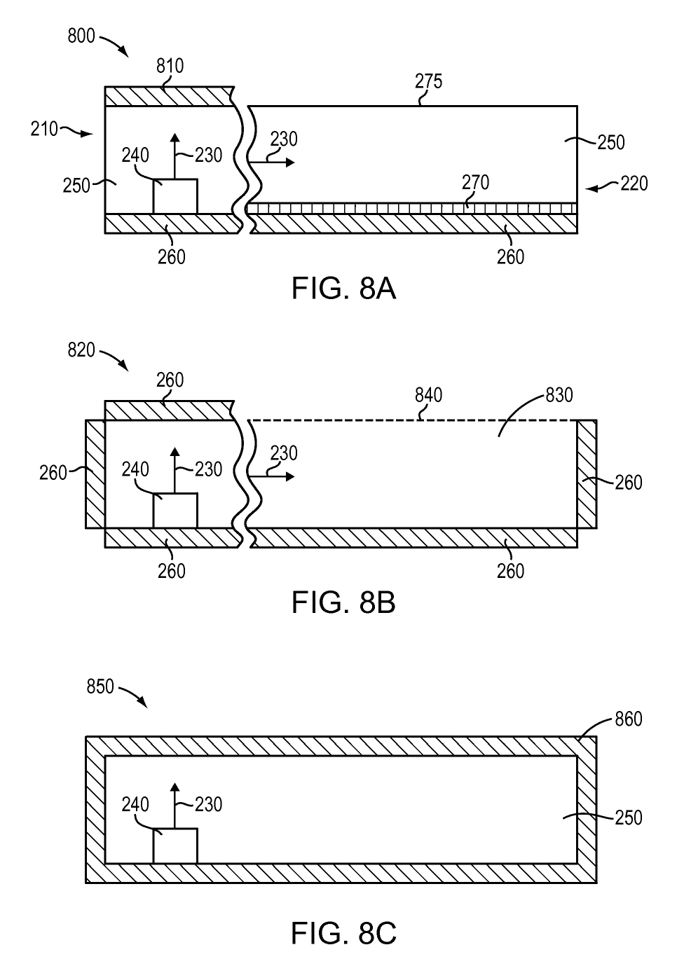

FIGS. 8A-8C depict alternative light-guiding structures that may be utilized as alternatives to the specific waveguide structure utilized in FIGS. 2, 3A, 3B, 4A, 4B, and 5A-5C. In FIGS. 8A-8C, the precise details of the phosphor layers (except in FIG. 8C) and reflector layers have not been illustrated, but the structures depicted therein may be utilized with any of the phosphor layer (segmented or not) and/or reflector layer (e.g., segmented) and/or out-coupling structure (segmented or not) configurations depicted in FIGS. 2, 3A, 3B, 4A, 4B, and 5A-5C. FIG. 8A depicts an illumination device 800 similar to that depicted in FIG. 2 except that the one or more LEDs 240 are “bottom-coupled,” i.e., disposed proximate the bottom surface of waveguide 250 opposite the exit surface 275. Illumination device 800 may include an in-coupling structure 810 (which may include or consist essentially of, e.g., scattering particles, linear or shaped reflectors, prisms, etc.) to efficiently couple light 230 into waveguide 250. In other embodiments, illumination device 800 may not have distinct in-coupling and out-coupling regions, and thus one or more LEDs 240 will be disposed within a waveguide 250 all of which resembles an out-coupling region 220.

FIG. 8B depicts an illumination device 820 having a “light box” arrangement in which light is guided within substantially empty space 830 surrounded by reflectors 260 rather than within a solid waveguide. As shown, light is emitted from an opening 840 (effectively the exit “surface”) where a reflector 260 is not present. As mentioned above, a phosphor layer (segmented or not) and/or reflector layer (e.g., segmented) may be disposed at the opening 840, as desired. As described above for illumination device 800, in some embodiments of the invention illumination device 820 does not have distinct in-coupling and out-coupling regions, and is defined in its entirety by the empty space 830 with one or more LEDs 240 therewithin.

FIG. 8C depicts an illumination device 850 in which multiple sides (including, e.g., all sides) of the waveguide 250 are surrounded by a phosphor layer 860 (illustrated as continuous but which may be segmented on one or more surfaces of waveguide 250, as desired). One or more reflector layers (segmented or not) may be disposed over or intermingled with (in the case of a segmented phosphor layer and a segmented reflector layer) phosphor layer 860 on one or more sides of the waveguide 250.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An illumination apparatus comprising:
a substantially planar waveguide having (i) top and bottom opposed surfaces, (ii) an in-coupling region for receiving light, and (iii) an out-coupling region for emitting light, the out-coupling region comprising at least a portion of the top surface of the waveguide;
at least one light source for emitting light into the in-coupling region;
an out-coupling structure, disposed in the out-coupling region, for disrupting total internal reflection of light within the waveguide such that the light is emitted from the out-coupling region; and
a segmented layer of photoluminescent material, different from the out-coupling structure, for converting a portion of light emitted from the out-coupling region to a different wavelength, disposed over the out-coupling region to form a gap between each segment of the segmented layer of photoluminescent material and the top surface of the waveguide.

2. The illumination apparatus of claim 1, further comprising a reflector, disposed proximate the bottom surface of the waveguide at least in the out-coupling region, for preventing emission of light from the bottom surface.

3. The illumination apparatus of claim 1, wherein (i) the at least one light source emits light of a first color, (ii) light of the first color is emitted from the out-coupling region between segments of the segmented layer of photoluminescent material, (iii) the segments of the segmented layer of photoluminescent material emit light of a second color different from the first color, and (iv) light of the first and second colors combine to form light of a third color.

4. The illumination apparatus of claim 1, wherein the out-coupling structure comprises a plurality of discrete optical elements.

5. The illumination apparatus of claim 4, wherein the optical elements comprise at least one of prisms, hemispheres, or diffusive dots.

6. The illumination apparatus of claim 4, wherein, as a function of distance from the at least one light source, (i) a spacing between segments of the segmented layer of photoluminescent material is substantially constant, and (ii) a spacing between optical elements decreases.

7. The illumination apparatus of claim 1, further comprising a plurality of opaque reflectors, each disposed between segments of the segmented layer of photoluminescent material.

8. The illumination apparatus of claim 7, wherein top surfaces of the opaque reflectors and the segments of the segmented layer of photoluminescent material are substantially coplanar.

9. The illumination apparatus of claim 7, wherein each of the opaque reflectors (i) comprises a thermally conductive material and (ii) is thermally connected to a heat sink proximate an edge of the waveguide.

10. The illumination apparatus of claim 7, wherein (i) top surfaces of the segments of the segmented layer of photoluminescent material are a first color, and (ii) top surfaces of a first portion of the opaque reflectors are a second color different from the first color.

11. The illumination apparatus of claim 10, wherein the second color is complementary to the first color, and at least a portion of a top surface of the illumination apparatus encompassing the segmented layer of photoluminescent material and the first portion of the opaque reflectors appears white to the human eye.

12. The illumination apparatus of claim 10, wherein top surfaces of a second portion of the opaque reflectors are one or more third colors different from the first and second colors, and the second portion of the opaque reflectors are arranged in a predetermined pattern.

13. The illumination apparatus of claim 1, wherein the out-coupling structure comprises a segmented layer of optical elements, segments of the out-coupling structure being arranged to direct light toward segments of the segmented layer of photoluminescent material.

14. The illumination apparatus of claim 13, further comprising an optical diffuser disposed over the segmented layer of photoluminescent material.

15. The illumination apparatus of claim 1, wherein (i) the out-coupling structure comprises a segmented layer of optical elements arranged to direct light toward specific areas of the top surface of the waveguide, (ii) the segments of the segmented layer of photoluminescent material are movable relative to the specific areas of the top surface of the waveguide, and (iii) a correlated color temperature of light emitted by the illumination apparatus is dependent on locations of the segments of the segmented layer of photoluminescent material.

16. The illumination apparatus of claim 15, further comprising an optical diffuser disposed over the segmented layer of photoluminescent material.

17. The illumination apparatus of claim 1, wherein the out-coupling structure is proximate the bottom surface of the waveguide.

18. An illumination apparatus comprising:
a substantially planar waveguide having (i) top and bottom opposed surfaces, (ii) an in-coupling region for receiving light, and (iii) an out-coupling region for emitting light, the out-coupling region comprising at least a portion of the top surface of the waveguide;
at least one light source for emitting light into the in-coupling region;
an out-coupling structure, disposed in the out-coupling region, for disrupting total internal reflection of light within the waveguide such that the light is emitted from the out-coupling region;
a layer of photoluminescent material, for converting a portion of light emitted from the out-coupling region to a different wavelength, disposed over the out-coupling region to form a gap between the layer of photoluminescent material and the top surface of the waveguide; and
disposed over the layer of photoluminescent material, a plurality of opaque reflectors different from the out-coupling structure and having spaces therebetween, light being emitted from the illumination apparatus only through the spaces.

19. The illumination apparatus of claim 18, wherein (i) a top surface of the layer of photoluminescent material is a first color, and (ii) top surfaces of a first portion of the opaque reflectors are a second color different from the first color.

20. The illumination apparatus of claim 19, wherein the second color is complementary to the first color, and at least a portion of a top surface of the illumination apparatus encompassing a portion of the layer of photoluminescent material and the first portion of the opaque reflectors appears white to the human eye.

21. The illumination apparatus of claim 19, wherein top surfaces of a second portion of the opaque reflectors are one or more third colors different from the first and second colors, and the second portion of the opaque reflectors are arranged in a predetermined pattern.

22. The illumination apparatus of claim 18, wherein a spacing between opaque reflectors as a function of distance from the at least one light source is approximately constant.

23. The illumination apparatus of claim 18, wherein a spacing between opaque reflectors as a function of distance from the at least one light source varies in a predetermined manner.

24. The illumination apparatus of claim 18, further comprising a second plurality of opaque reflectors disposed over the plurality of opaque reflectors, wherein relative motion between the plurality of opaque reflectors and the second plurality of opaque reflectors alters a luminance of light emitted from the illumination apparatus.

25. The illumination apparatus of claim 18, wherein the out-coupling structure comprises a plurality of discrete optical elements.

26. The illumination apparatus of claim 25, wherein the optical elements comprise at least one of prisms, hemispheres, or diffusive dots.

27. The illumination apparatus of claim 18, wherein the out-coupling structure is proximate the bottom surface of the waveguide.

28. The illumination apparatus of claim 18, wherein each of the opaque reflectors (i) comprises a thermally conductive material and (ii) is thermally connected to a heat sink proximate an edge of the waveguide.
